(19) United States
(12) Patent Application Publication
(10) Pub. No.: US 2026/0261370 A1
(43) Pub. Date: Sep. 3, 2026

(54) SUPPORTING FREQUENCY MULTIPLEXING OF ORTHOGONAL FREQUENCY DIVISION MULTIPLEXING AND SINGLE CARRIER MODULATION

(71) Applicant: Telefonaktiebolaget LM Ericsson (publ), Stockholm (SE)

(72) Inventors: Leif WILHELMSSON, Lund (SE); Miguel LOPEZ, Solna (SE)

(21) Appl. No.: 18/880,019

(22) PCT Filed: Jul. 12, 2022
(86) PCT No.: PCT/EP2022/069481

§ 371 Date: Dec. 30, 2024

(51) Int. Cl. H04L 5/00; H04L 27/20

(52) U.S. Cl. CPC H04L 5/0007; H04L 27/2082

(57) ABSTRACT

A transmitter can multiplex orthogonal frequency division multiplexing (“OFDM”) modulated data and single carrier (“SC”) modulated data. The transmitter can, responsive to determining to transmit first user data to a first receiver using OFDM modulation and to transmit second user data to a second receiver using SC modulation, generate a transmission (“Tx”) signal by multiplexing the OFDM modulated data and the SC modulated data. The transmitter can transmit the Tx signal to the first receiver and the second receiver.

### TECHNICAL FIELD

The present disclosure is related to wireless communication systems and more particularly to supporting frequency multiplexing of orthogonal frequency division multiplexing (“OFDM”) and single carrier (“SC”) modulation.

### BACKGROUND

FIG. 1 illustrates an example of a new radio (“NR”) network (e.g., a 5th Generation (“5G”) network) including a 5G core (“5GC”) network 130, network node 120 (e.g., 5G base station (“gNB”)), and a communication device 110 (also referred to as user equipment (“UE”)).

The design of the physical layer for a wireless communication system can be based on several factors (e.g., the data rate that needs to be supported and the targeted power consumption). As the required data rates needed to be supported has increased considerably so has the needed channel bandwidth. Systems that are designed for supporting large data rates can be based on orthogonal frequency division multiplexing (“OFDM”). This can allow for comparatively simple equalization at the receiver side. Another desirable feature of OFDM is that it allows for a straight-forward way to multiplex transmissions to and from several users by means of orthogonal frequency division multiple access (“OFDMA”).

One of the major disadvantages with OFDM is that it suffers from a large peak-to-average ratio (“PAPR”). Because of the large PAPR, the linearity requirements can be higher both in the transmitter and in the receiver and as a result the power efficiency can be relatively poor. In some examples associated with power limited devices, the maximum transmission (“Tx”) power that can be used may simply make OFDM an unattractive or even unfeasible approach. OFDM is used, for example, in Wi-Fi and Long Term Evolution (“LTE”).

In some examples, power consumption is a bigger concern than the available data rate. In these examples, single carrier (“SC”) modulation can be used rather than, for example, OFDM modulation. When SC modulation is used, a distinction can be made between linear modulation and constant envelope modulation. Examples of the linear modulation include phase shift keying (“PSK”) and quadrature amplitude modulation (“QAM”). Examples of constant envelope modulation include Gaussian frequency shift keying (“GFSK”). Linear modulation can allow for higher spectrum efficiency (e.g., a larger modulation alphabet), whereas constant envelope (which is often a non-linear modulation) can give the best power efficiency and therefore may be the preferred choice in case of binary modulation. SC modulation, and in particular GFSK, is used in Bluetooth Low Energy (“BLE”).

5G NR supports OFDM and SC-frequency division multiple access (“FDMA”). The network can decide which modulation should be used by the UE. SC-FDMA can be employed when the UE is at the cell edge, because it has lower PAPR than OFDM.

### SUMMARY

According to some embodiments, a method performed by a transmitter is provided to multiplex orthogonal frequency division multiplexing (“OFDM”) modulated data and single carrier (“SC”) modulated data. The method includes, responsive to determining to transmit first user data to a first receiver using OFDM modulation and to transmit second user data to a second receiver using SC modulation, generating a transmission (“Tx”) signal by multiplexing the OFDM modulated data and the SC modulated data. The method further includes transmitting the Tx signal to the first receiver and the second receiver.

According to other embodiments, a method performed by a device is provided to support frequency multiplexing of orthogonal frequency division multiplexing (“OFDM”) modulated data and single carrier (“SC”) modulated data. The method includes determining information about how a first transmitter and a second transmitter will transmit user data to the device. The method further includes receiving a reception (“Rx”) signal based on a first transmission (“Tx”) signal transmitted by the first transmitter and a second Tx signal transmitted by the second transmitter. The first Tx signal includes OFDM modulated data associated with the device and the second Tx signal includes SC modulated data associated with the device. The Rx signal includes the OFDM modulated data and SC modulated data. The method further includes determining the user data from the Rx signal based on the information.

According to other embodiments, a method performed by a transmitter is provided to support frequency multiplexing of orthogonal frequency division multiplexing (“OFDM”) modulation and single carrier (“SC”) modulation. The method includes receiving an indication of whether a receiver is capable of demodulating frequency multiplexed OFDM modulated data and SC modulated data. The method can include transmitting an indication to the receiver of whether the transmitter will transmit a signal comprising frequency multiplexed OFDM modulated data and SC modulated data.

According to other embodiments, a method performed by a device is provided to support frequency multiplexing of orthogonal frequency division multiplexing (“OFDM”) modulation and single carrier (“SC”) modulation. The method can include transmitting an indication that the device supports receiving frequency multiplexed OFDM modulated data and SC modulated data. The method can further include receiving an indication from the transmitter of whether the transmitter will transmit a signal comprising frequency multiplexed OFDM modulated data and SC modulated data.

According to other embodiments, a device, an access point, a communication device, a transmitter, a receiver, a non-transitory readable medium, a computer program, or a computer program product is provided to perform one of the above methods.

Certain embodiments may provide one or more of the following technical advantages. In some embodiments, a single standard and a single transceiver can effectively support use cases ranging from very high data rates to very low power consumption. Because very different use cases can be supported concurrently, for example, by means of frequency division multiplexing (“FDM”), rather than by time division multiplexing (“TDM”), the scheduling can be significantly improved and in addition support for delay critical applications can be enhanced.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of a communications network capable of supporting frequency multiplexing of OFDM modulated data and SC modulated data in accordance with some embodiments;

FIG. 3 is a block diagram illustrating an example of a transmitter supporting frequency multiplexing of OFDM modulated data and SC modulated data in accordance with some embodiments;

FIG. 4 is a block diagram illustrating an example of a receiver supporting frequency multiplexing of OFDM modulated data and SC modulated data in accordance with some embodiments;

FIG. 5 is a flow chart illustrating an example of operations performed by a transmitter for supporting frequency multiplexing of OFDM modulated data and SC modulated data in accordance with some embodiments;

FIG. 6 is a flow chart illustrating an example of operations performed by a receiver for supporting frequency multiplexing of OFDM modulated data and SC modulated data in accordance with some embodiments;

FIG. 7 is a block diagram of a communication system in accordance with some embodiments;

FIG. 8 is a block diagram of a user equipment in accordance with some embodiments;

FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments; and

FIG. 12 is a block diagram of a host computer communicating via a base station with a user equipment over a partially wireless connection in accordance with some embodiments in accordance with some embodiments.

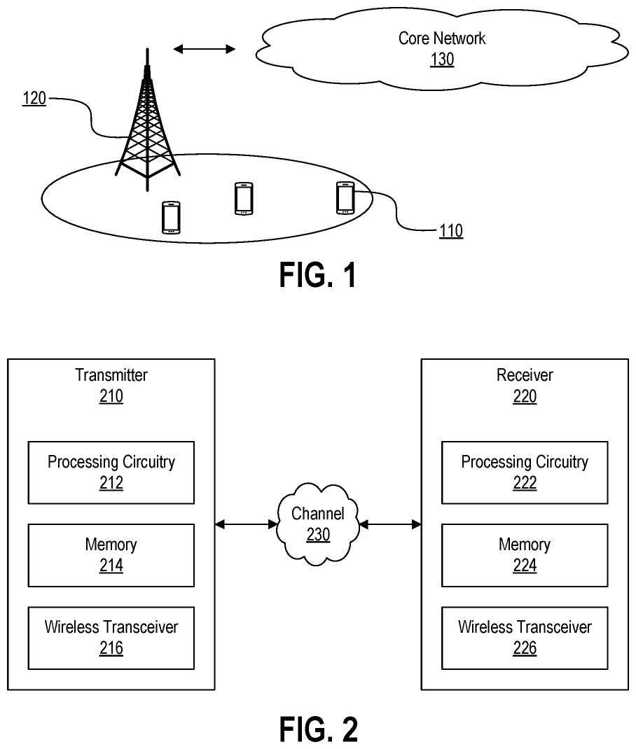

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There is currently no standard able to both support high data rate and low power application concurrently. Thus, to support both high data rate and low power applications, two different standards (e.g., Wi-Fi to support high data rate and BLE to support low power) need to be implemented. One drawback with this is that the solution most likely will be more costly. Another drawback is the coexistence between the two standards. Specifically, assuming that the two standards are operating in the same frequency band, there may be severe in-device coexistence problems if one of the standards is transmitting while the other standard is receiving. Avoiding simultaneous transmission and reception (“STR”) can be challenging if the standards are based on different protocols. Thus, either time multiplexing of the standards or expensive filters combined with complex interference suppression techniques may have to be used. In addition, even with a single standard, the support of both high data rate and low power consumption can be based on two different modes and the use of these modes can be by means of time division multiplexing (e.g., only one of the modes would be used at a time).

Various embodiments described herein propose an operation in which a single transceiver is designed to support multiplexing of different modulations concurrently. Specifically, the transceiver is able to frequency multiplex orthogonal frequency division multiplexing (“OFDM”) with single carrier (“SC”) modulation. This can be achieved by not populating a suitable number of sub-carriers in the OFDM signal and instead transmit the SC modulation in this bandwidth. The OFDM signal and the SC modulation signal can be synchronized in time such that no STR occurs, thus allowing for low complex coexistence which can be required for low-cost devices. One of the key parameters to take into account is which one of the available modulations to select.

FIG. 2 illustrates an example of a communications system that supports frequency multiplexing OFDM modulated data with SC modulated data. The communications system includes a transmitter 210 communicatively coupled to a receiver 220 via a channel 230. The transmitter 210 includes processing circuitry 212, memory 214, and a wireless transceiver 216. The receiver 220 includes processing circuitry 222, memory 224, and a wireless transceiver 226.

In some embodiments, it is possible to select whether to use OFDM modulation or SC modulation for transmitting data from a first device (e.g., transmitter 210) to a second device (e.g., a device including receiver 220). In some examples, the selection is based on at least one of a required date rate and a requirement of low power consumption. In additional or alternative examples, in addition to the transmission to the second device there is also a transmission from the first device to a third device (e.g., another device including another receiver). The transmissions to the second device can be based on orthogonal frequency division multiple access (“OFDMA”) whereas the transmission to the third device can be based on SC modulation.

In additional or alternative embodiments, a device can include a first receiver and a second receiver. In some examples, the transmitter 210 transmits a Tx signal to the first receiver and the second receiver. The first receiver can determine OFDM modulated data from the Tx signal and the second receiver can determine SC modulated data from the Tx signal.

In additional or alternative embodiments, a device can include a network node (e.g., an access point (“AP”), a base station, or a radio access network (“RAN”) node) or a communication device (e.g., a terminal device, a UE, or a mobile device).

In additional or alternative embodiments, at least one of the data rates is supported by both SC modulation and OFDM modulation.

In additional or alternative embodiments, a SC modulated signal is multiplexed in frequency with an OFDM signal and the signals are transmitted to different receivers.

In additional or alternative embodiments, the subcarriers located at the same frequency as the SC signal are not used. In some examples, the subcarriers that are not used are set to approximately zero by nulling (or muting) an amplitude of the OFDM signal at the subcarrier.

In additional or alternative embodiments, the number of subcarriers not used is the minimum number of sub-carriers that can be allocated to a user using OFDMA.

In additional or alternative embodiments, the number of subcarriers not used is an integer multiple (greater than 1) of the minimum number of sub-carriers that can be allocated to a user using OFDMA.

In some embodiments, it is possible to select whether to use OFDM or SC modulation for receiving data from a second device. In some examples, the selection is based on at least one of the required date rate and the requirement of low power consumption. In additional or alternative examples, in addition to the reception of the transmission from the second device is a transmission from a third device, and where the transmissions from the second device is based on OFDMA whereas the transmission from the third device is based on SC modulation.

Various embodiments herein allow for a single standard. In some embodiments, a single transceiver can effectively support use cases ranging from very high data rates to very low power consumption. In some examples, different use cases can be supported concurrently, for example, by means of frequency division multiplexing (“FDM”), rather than by time division multiplexing (“TDM”). The scheduling can become significantly improved and in addition support for delay critical applications can be enhanced.

Embodiments below are described in regards to a system that employs OFDMA for supporting high data rate to multiple users and SC modulation for allowing for low power consumption. In some examples, the SC can be exemplified with quadrature amplitude modulation (“QAM”) and Gaussian frequency shift keying (“GFSK”), but other alternatives are also feasible.

In some examples, it can be assumed that the OFDMA is based on the same parameters as currently used in in IEEE 802.11ax. For a 20 MHz channel, a 256 points Inverse Fast Fourier Transform (“IFFT”) can be used in the transmitter, resulting in a sub-carrier spacing of 20 MHz/256=78.125 kHz. This, in turn, can correspond to a symbol duration of 12.8 us excluding the cyclic prefix (“CP”). A commonly used size of the CP is 800 ns so that the OFDM symbol duration including the CP becomes 13.6 μs.

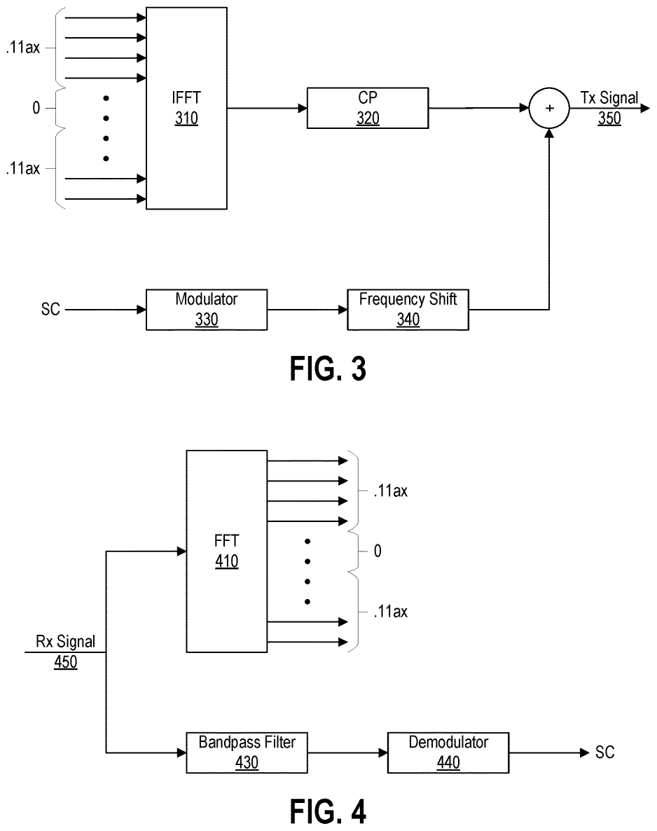

FIG. 3 illustrates an example of a transmitter (e.g., in a wireless transceiver 216 of transmitter 210 in FIG. 2) capable of multiplexing two signals using FDM. In this example, an IFFT 310 and CP 320 are used to generate an OFDM modulated signal with an unused frequency range. A modulator 330 can generate a SC modulated signal and a frequency shift 340 can shift the center frequency of the SC modulated signal to the center of the unused frequency range. The OFDM modulated signal and the SC modulated signal can be combined (e.g., multiplexed/added) to generate a transmission (“Tx”) signal 350.

In some examples, some of the sub-carriers in the OFDM signal are not used (the corresponding inputs to the IFFT are set to zero), and the SC modulated signal is shifted in frequency so that it allocates the part of the channel bandwidth that in this way is not used by the OFDM signal. In practice, the OFDM signal will not be perfectly zero even if the corresponding sub-carriers are set to zero due to the leakage in the IFFT. Similarly, the SC modulated signal will not be identically zero outside of the channel for which it is allocated. However, by selecting the number of sub-carriers set to zero sufficiently large and selecting the relative power of the two signals properly the interference between the two signals can be ensured to be at a sufficiently low level for both systems.

FIG. 4 illustrates an example of a receiver (e.g., in a wireless transceiver 226 of receiver 220 in FIG. 2) capable of separating SC modulated data or OFDM modulated data from a received (“Rx”) signal 450 received from the transmitter. A FFT 410 can separate out the OFDM modulated data and a bandpass filter 430 can separate out the SC modulated data, which can be demodulated by demodulator 440.

In additional or alternative examples, systems are described where one of the systems is based on OFDM whereas the other in not based on OFDM. In some embodiments, link adaptation is used to ensure that both systems can operate concurrently. Issues related to non-synchronized operation between the two systems may not have to be considered. Some embodiments can be useful when it is desired to migrate spectrum from one technology (e.g., GSM, which uses SC) to another technology (e.g., LTE which uses OFDM) and during the migration period it can be necessary to operate both systems concurrently and independently.

In some embodiments, a transmitter is provided for sending user data, where single carrier modulation and OFDM can be multiplexed in frequency.

In additional or alternative embodiments, the SC modulation and the OFDM modulation are used concurrently for transmitting data. According to this embodiment, SC is used for transmission of data to at least one receiver and in addition OFDM is used for transmission of data to at least one receiver.

The amount of bandwidth used for SC and OFDM, respectively, may be flexible and, for example, depend on how much data is sent using SC and OFDM, respectively. Moreover, the flexibility may be in fixed steps so that the bandwidth used for SC would be in steps of, for example, 1 MHz. Alternatively, the fixed steps may be in steps of a predetermined number of sub-carriers, for example, 26 sub-carriers. The predetermined number of sub-carries may, for example, correspond to the smallest amount of sub-carriers allocated to a user when OFDMA is employed.

In some examples, the transmitter may use a SC waveform to control the error vector magnitude (“EVM”) of the OFDM signal and to avoid the need for guard bands to separate the SC and OFDM signals.

In some embodiments, a receiver is provided for receiving user data, where single carrier modulation and OFDM can be multiplexed in frequency.

In additional or alternative embodiments, deciding how many sub-carriers should not be used can be based on the bandwidth of the SC signal, the frequency error for the UL signals, and the maximum power offset between the OFDM signal and the SC signal.

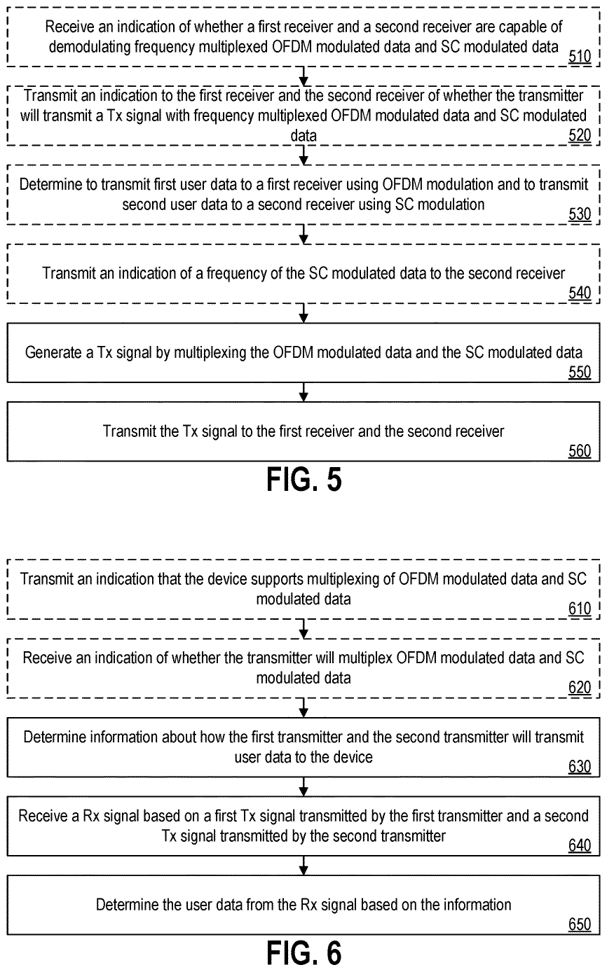

In the description that follows, while the transmitter may be any of communication device 110, network node 120, transmitter 210, wireless device 712A, 712B, wired or wireless devices UE 712C, UE 712D, UE 800, network node 710A, 710B, core network node 708, network node 900, virtualization hardware 1104, virtual machines 1108A, 1108B, or UE 1206, the transmitter 210 shall be used to describe the functionality of the operations of the transmitter. Operations of the transmitter 210 (implemented using the structure of the block diagram of FIG. 2) will now be discussed with reference to the flow charts of FIG. 5 according to some embodiments of inventive concepts. For example, modules may be stored in memory 214 of FIG. 2, and these modules may provide instructions so that when the instructions of a module are executed by respective transmitter processing circuitry 212, processing circuitry 212 performs respective operations of the flow charts.

FIG. 5 illustrates an example of operations performed by a transmitter to frequency multiplex OFDM modulated data and SC modulated data. In some embodiments, the transmitter only performs the operations in blocks 550 and 560. In other embodiments, the transmitter performs the operations in blocks 550 and 560 as well as one or more of the operations in blocks 510, 520, 530, and 540. In additional or alternative embodiments, the transmitter performs any one or more of the operations in blocks 510, 520, 530, 540, 550, and 560.

At block 510, processing circuitry 212 receives, via wireless transceiver 216, an indication of whether a receiver supports frequency multiplexing of OFDM modulated data and SC modulated data. In some examples, the indication is in response to a broadcast signal (e.g., a beacon). In additional or alternative examples, the indication is received as part of a random access (“RA”) procedure or as part of radio resource control (“RRC”) signaling. In additional or alternative examples, the indication indicates a type of the receiver and the transmitter determines whether the receiver supports frequency multiplexing of OFDM modulated data and SC modulated data based on the type of the receiver.

At block 520, processing circuitry 212 transmits, via wireless transceiver 216, an indication to the receiver of whether the transmitter will use frequency multiplexing of OFDM modulated data and SC modulated data. In some embodiments, the indication is transmitted independently from receiving (in block 510) the indication of whether the receiver supports frequency multiplexing of OFDM modulated data and SC modulated data. In other embodiments, the indication is transmitted in response to (and based on) receiving the indication of whether the receiver supports frequency multiplexing of OFDM modulated data and SC modulated data.

At block 530, processing circuitry 212 determines to transmit first user data to a first receiver using OFDM modulation and to transmit second user data to a second receiver using SC modulation. In some embodiments, the first receiver and the second receiver are part of a single device. In additional or alternative embodiments, the first receiver is part of a first device and the second receiver is part of a second device that is different than the first device.

In additional or alternative embodiments, determining to transmit the first user data to the first receiver using the OFDM modulation and to transmit the second user data to the second receiver using the SC modulation is based on information.

The information includes at least one of: characteristics of a channel between the transmitter and the first receiver; characteristics of a channel between the transmitter and the second receiver; a type of the transmitter; a type of the first receiver; a type of the second receiver; data rate requirements associated with the transmitter; data rate requirements associated with the first receiver; data rate requirements associated with the second receiver; power consumption requirements associated with the transmitter; power consumption requirements associated with the first receiver; and power consumption requirements associated with the receiver.

At block 540, processing circuitry 212 transmits, via wireless transceiver 216, an indication of a frequency of the SC modulated data to the second receiver.

In some examples, the indication is transmitted to the second receiver as part of the information.

At block 550, processing circuitry 212 generates a Tx signal. In some embodiments, generating the Tx signal includes generating a SC modulated signal based on the second user data. The SC modulated signal can have a center frequency at a predetermined frequency. In some examples, generating the SC modulated signal includes generating an initial signal at baseband based on the second user data and frequency shifting the initial signal to generate the SC modulated signal. Generating the Tx signal can further include generating an OFDM signal based on the first user data in which a subcarrier at the predetermined frequency is unused and multiplexing the SC modulated signal and the OFDM signal to form the Tx signal. In some examples the Tx signal includes both the OFDM modulated data and the SC modulated data.

In some examples, the subcarrier is a first subcarrier of a plurality of subcarriers in the OFDM signal whose amplitude are set to zero (e.g., within a threshold value of zero). In some examples, the subcarrier has a null/muted amplitude. A number of subcarriers in the plurality of subcarriers in the OFDM signal that are unused is based on a minimum number of subcarriers that can be allocated to a user using orthogonal frequency division multiple access, OFDMA.

At block 560, processing circuitry 212 transmits, via wireless transceiver 216, the Tx signal to the first receiver and the second receiver. In some embodiments, the transmitter comprises an access point. In additional or alternative embodiments, a communication device includes at least one of the first receiver and the second receiver. In additional or alternative embodiments, the Tx signal includes a downlink (“DL”) signal.

In other embodiments, the transmitter includes a communication device. In additional or alternative embodiments, an access point includes at least one of the first receiver and the second receiver. In additional or alternative embodiments, the Tx signal comprises an uplink (“UL”) signal.

In additional or alternative embodiments, the OFDM modulation is a high bandwidth modulation including at least one of: Institute of Electrical and Electronics Engineers (“IEEE”) modulation; and 3^{rd} Generation Partnership Project (“3GPP”) modulation. The SC modulation includes at least one of: quadrature amplitude modulation (“QAM”); quadrature phase shift keying (“QPSK”); and constant envelope modulation.

In additional or alternative embodiments, the OFDM modulation and the SC modulation are based on a common radio access technology (“RAT”). In some examples, the common RAT is a BLUETOOTH wireless technology.

Various operations of FIG. 5 may be optional. In some embodiments, blocks 510, 520, 530, and 540 may be optional. In other embodiments, blocks 530, 540, 550, and 560 may be optional.

In the description that follows, while the receiver may be any of communication device 110, network node 120, receiver 220, wireless device 712A, 712B, wired or wireless devices UE 712C, UE 712D, UE 800, network node 710A, 710B, core network node 708, network node 900, virtualization hardware 1104, virtual machines 1108A, 1108B, or UE 1206, the receiver 220 shall be used to describe the functionality of the operations of the receiver. Operations of the receiver 220 (implemented using the structure of the block diagram of FIG. 2) will now be discussed with reference to the flow charts of FIG. 6 according to some embodiments of inventive concepts. For example, modules may be stored in memory 224 of FIG. 2, and these modules may provide instructions so that when the instructions of a module are executed by respective receiver processing circuitry 222, processing circuitry 222 performs respective operations of the flow charts.

FIG. 6 illustrates an example of operations performed by a device to support frequency multiplex OFDM modulated data and SC modulated data. In some embodiments, the device only performs the operations in blocks 630, 640, and 650. In other embodiments, the device performs the operations in blocks 630, 640, and 650 as well as one or more of the operations in blocks 610 and 620. In additional or alternative embodiments, the device performs any one or more of the operations in blocks 610, 620, 630, 640, and 650.

At block 610, processing circuitry 222 transmits, via wireless transceiver 226, an indication that the device supports receiving frequency multiplexed OFDM modulated data and SC modulated data. In some examples, transmitting the indication includes transmitting the indication via a broadcast signal.

In some embodiments, processing circuitry 222 transmits, via wireless transceiver 226, information to the first transmitter indicating a subcarrier of the first Tx signal to avoid using for the OFDM modulated data.

In additional or alternative embodiments, processing circuitry 222 transmits, via wireless transceiver 226, information to the second transmitter indicating a frequency to use for the SC modulated data in the second Tx signal.

At block 620, processing circuitry 222 receives, via wireless transceiver 226, an indication that the device supports frequency multiplexing of OFDM modulated data and SC modulated data.

At block 630, processing circuitry 222 determines information about how a first transmitter and a second transmitter will transmit user data to the device. In some embodiments, determining the information includes determining a frequency of the SC modulated data. In some examples, determining the frequency includes receiving an indication of the frequency from the first transmitter or the second transmitter.

At block 640, processing circuitry 222 receives, via wireless transceiver 226, a reception (“Rx”) signal based on a first transmission (“Tx”) signal transmitted by the first transmitter and a second Tx signal transmitted by the second transmitter. The first Tx signal can include OFDM modulated data associated with the device and the second Tx signal can include SC modulated data associated with the device. The Rx signal can include the OFDM modulated data and the SC modulated data.

In some embodiments, receiving the Rx signal includes receiving the first Tx signal and the second Tx signal concurrently. The Rx signal can include the OFDM modulated data and SC modulated data multiplexed together.

At block 650, processing circuitry 222 determines the user data from the Rx signal based on the information. In some embodiments, the device includes a first receiver to demodulate OFDM modulated data and a second receiver to demodulate SC modulated data. In additional or alternative embodiments, determining the user data from the Rx signal includes determining the OFDM modulated data from the Rx signal using the first receiver and the SC modulated data from the Rx signal using the second receiver.

In some embodiments, determining the information includes determining a frequency of the SC modulated data and determining the user data includes filtering out frequencies other than the frequency of the SC modulated data.

In some examples, determining the information includes determining a frequency of the SC modulated data. Determining the user data includes filtering out frequencies other than the frequency of the SC modulated data. In some examples, determining the frequency includes receiving an indication of the frequency from the transmitter.

In some embodiments, the device includes a first receiver and a second receiver. The user data includes first user data and second user data. Determining the user data includes: determining the first user data from the OFDM modulated data based on the information; and determining the second user data from the SC modulated data based on the information.

Various operations of FIG. 6 may be optional. In some embodiments, blocks 610, 620, and 650 may be optional. In other embodiments, blocks 630, 640, and 650 may be optional.

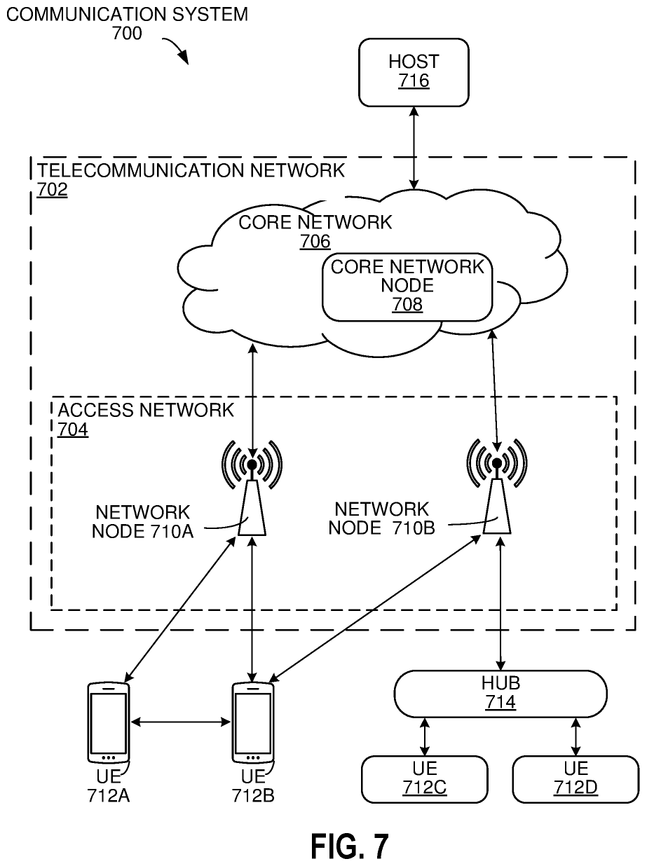

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. Moreover, as will be appreciated by those of skill in the art, the network nodes 710 are not necessarily limited to an implementation in which a radio portion and a baseband portion are supplied and integrated by a single vendor. Thus, it will be understood that the network nodes 710 may include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 710 facilitate direct or indirect connection of user equipment (UE), such as by connecting wireless devices 712a, 712b, 712c, and 712d (one or more of which may be generally referred to as UEs 712) to the core network 706 over one or more wireless connections. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub-that is, a hub whose primary function is to route communications to/from the UEs from/to the network node 710b. In other embodiments, the hub 714 may be a non-dedicated hub-that is, a device which is capable of operating to route communications between the UEs and network node 710b, but which is additionally capable of operating as a communication start and/or end point for certain data channels.

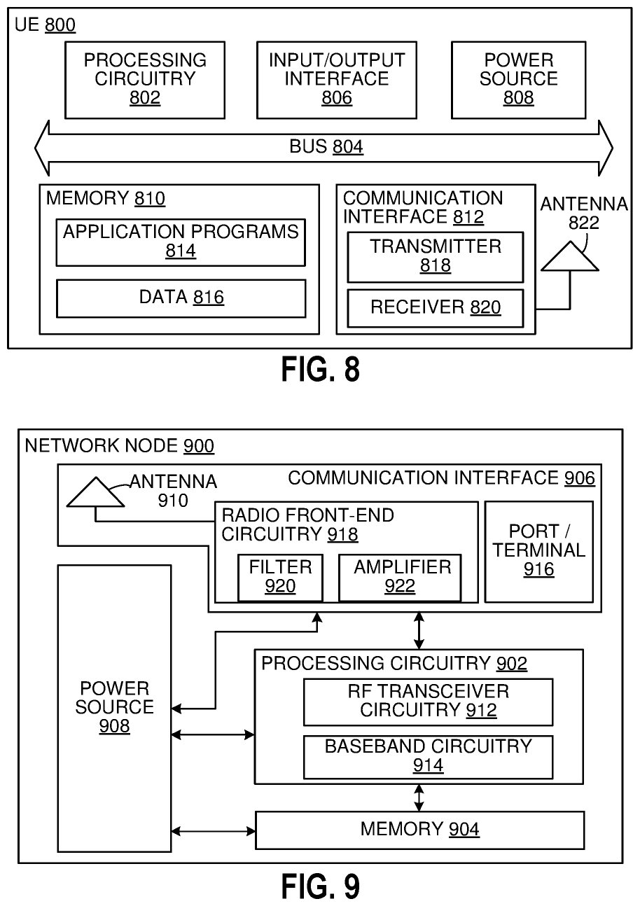

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (Iot) device, may be a device for use in one or more application domains, these domains comprising, but not limited to, city wearable technology, extended industrial application and healthcare. Non-limiting examples of such an Iot device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an Iot device comprises circuitry and/or software in dependence of the intended application of the Iot device in addition to other components as described in relation to the UE 800 shown in FIG. 8.

As yet another specific example, in an Iot scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node.

Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein.

For example, the network node 900 may include user interface equipment to allow input of information into the network node 900 and to allow output of information from the network node 900. This may allow a user to perform diagnostic, maintenance, repair, and other administrative functions for the network node 900.

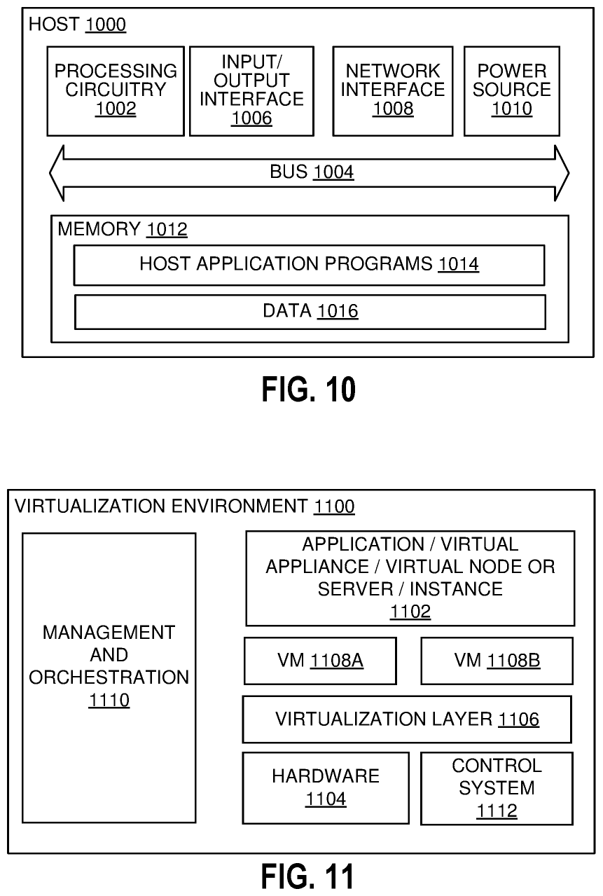

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

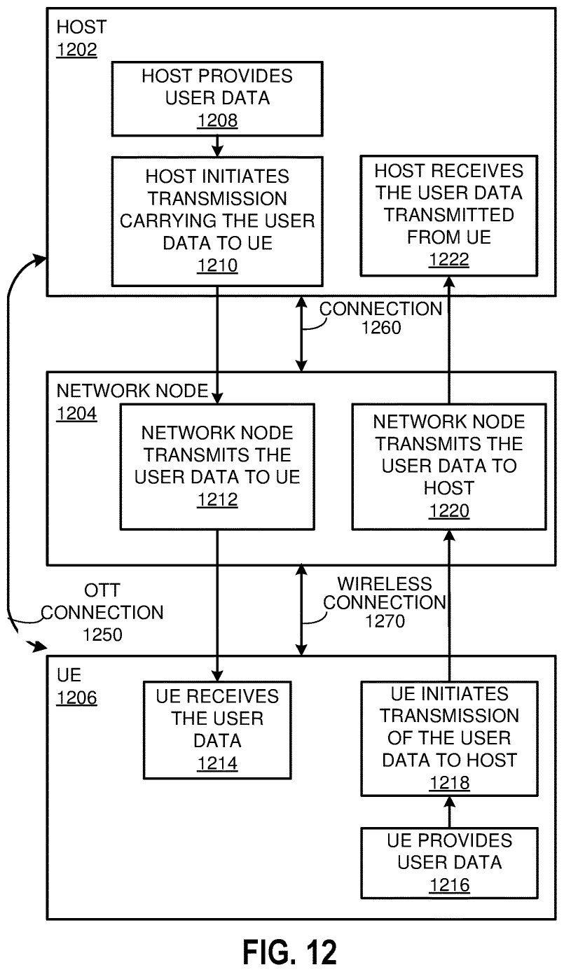

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206.

Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may allow for a single transceiver to effectively support use cases ranging from very high data rates to very low power consumption. Because very different use cases can be supported concurrently (e.g., by means of frequency division multiplexing (FDM) rather than by time division multiplexing (TDM)) the scheduling can be significantly improved and in additional support for delay critical applications can be enhanced.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc. ; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a transmitter for multiplexing orthogonal frequency division multiplexing, OFDM, modulated data and single carrier, SC, modulated data, the method comprising:
responsive to determining to transmit first user data to a first receiver using OFDM modulation and to transmit second user data to a second receiver using SC modulation, generating a transmission, Tx, signal by multiplexing the OFDM modulated data and the SC modulated data; and
transmitting the Tx signal to the first receiver and the second receiver.

2. The method of claim 1, wherein generating the Tx signal comprises:
generating a SC modulated signal based on the second user data, the SC modulated signal having a center frequency at a predetermined frequency;
generating an OFDM signal based on the first user data in which a subcarrier at the predetermined frequency is unused; and
multiplexing the SC modulated signal and the OFDM signal to form the Tx signal.

3. The method of claim 2, wherein generating the SC modulated signal comprises:
generating an initial signal at baseband based on the second user data; and
frequency shifting the initial signal to generate the SC modulated signal.

4. The method of claim 2, wherein the subcarrier is a first subcarrier of a plurality of subcarriers in the OFDM signal, wherein each of the subcarriers in the plurality of subcarriers has a nulled amplitude, and wherein a number of subcarriers in the plurality of subcarriers in the OFDM signal is based on a minimum number of subcarriers that can be allocated to a user using orthogonal frequency division multiple access, OFDMA.

5.-8. (canceled)

9. The method of claim 1, further comprising:
determining to transmit the first user data to the first receiver using the OFDM modulation and to transmit the second user data to the second receiver using the SC modulation based on information, the information including at least one of:
characteristics of a channel between the transmitter and the first receiver;
characteristics of a channel between the transmitter and the second receiver;
a type of the transmitter;
a type of the first receiver;
a type of the second receiver;
data rate requirements associated with the transmitter;
data rate requirements associated with the first receiver;
data rate requirements associated with the second receiver;
power consumption requirements associated with the transmitter;
power consumption requirements associated with the first receiver; and
power consumption requirements associated with the second receiver.

10. The method of claim 1, further comprising:
transmitting an indication to the second receiver of a frequency at which the second user data will be transmitted.

11. The method of claim 1, wherein:
the OFDM modulation is a high bandwidth modulation comprising at least one of:
Institute of Electrical and Electronics Engineers, IEEE, modulation; and
3^{rd} Generation Partnership Project, 3GPP, modulation; and
wherein the SC modulation comprises at least one of:
quadrature amplitude modulation, QAM;
quadrature phase shift keying, QPSK; and
constant envelope modulation.

12. The method of claim 1, wherein the OFDM modulation and the SC modulation are based on a common radio access technology, RAT, and wherein the common RAT is a BLUETOOTH wireless technology.

13. (canceled)

14. The method of claim 1, further comprising:
receiving an indication that the first receiver and the second receiver are capable of demodulating frequency multiplexed OFDM modulated data and SC modulated data.

15. The method of claim 1, further comprising:
transmitting an indication to the first receiver and the second receiver indicating that the transmitter will transmit the Tx signal and that the Tx signal will include frequency multiplexed OFDM modulated data and SC modulated data.

16. A method performed by a device to support multiplexing orthogonal frequency division multiplexing, OFDM, modulated data and single carrier, SC, modulated data, the method comprising:
determining information about how a first transmitter and a second transmitter will transmit user data to the device;
receiving a reception, Rx, signal based on a first transmission, Tx, signal transmitted by the first transmitter and a second Tx signal transmitted by the second transmitter, the first Tx signal including OFDM modulated data associated with the device and the second Tx signal including SC modulated data associated with the device, the Rx signal including the OFDM modulated data and SC modulated data; and
determining the user data from the Rx signal based on the information.

17. The method of claim 16, wherein receiving the Rx signal comprises receiving the first Tx signal and the second Tx signal concurrently, and wherein the Rx signal including the OFDM modulated data and SC modulated data multiplexed together.

18. The method of claim 16, wherein the device comprises a first receiver to demodulate OFDM modulated data and a second receiver to demodulate SC modulated data, and wherein determining the user data from the Rx signal comprises determining the OFDM modulated data from the Rx signal using the first receiver and the SC modulated data from the Rx signal using the second receiver.

19. The method of claim 16, wherein determining the information comprises determining a frequency of the SC modulated data, and
wherein determining the user data comprises filtering out frequencies other than the frequency of the SC modulated data, and wherein determining the frequency comprises receiving an indication of the frequency from the first transmitter or the second transmitter.

20. (canceled)

21. The method of claim 16, further comprising:
transmitting an indication that the device supports receiving frequency multiplexed OFDM modulated data and SC modulated data.

22. The method of claim 21, wherein transmitting the indication comprises transmitting the indication via a broadcast signal.

23. The method of claim 21, wherein transmitting the indication comprises transmitting information to the first transmitter indicating a subcarrier of the first Tx signal to avoid using for the OFDM modulated data.

24. The method of claim 21, wherein transmitting the indication comprises transmitting information to the second transmitter indicating a frequency to use for the SC modulated data in the second Tx signal.

25. The method of claim 16, further comprising:
receiving an indication from the transmitter of whether the transmitter will frequency multiplex the OFDM modulated data and the SC modulated data.

26. A device that supports frequency multiplexing of orthogonal frequency division multiplexing, OFDM, and single carrier, SC, modulation, the device comprising:
processing circuitry; and
memory coupled to the processing circuitry and having instructions stored therein that are executable by the processing circuitry to cause the device to:
responsive to determining to transmit first user data to a first receiver using OFDM modulation and to transmit second user data to a second receiver using SC modulation, generate a transmission, Tx, signal by multiplexing the OFDM modulated data and the SC modulated data; and
transmit the Tx signal to the first receiver and the second receiver.

27.-29. (canceled)

30. A device that supports multiplexing orthogonal frequency division multiplexing, OFDM, modulated data and single carrier, SC, modulated data, the device comprising:
processing circuitry; and
memory coupled to the processing circuitry and having instructions stored therein that are executable by the processing circuitry to cause the device to:
determine information about how a first transmitter and a second transmitter will transmit user data to the device;
receive a reception, Rx, signal based on a first transmission, Tx, signal transmitted by the first transmitter and a second Tx signal transmitted by the second transmitter, the first Tx signal including OFDM modulated data associated with the device and the second Tx signal including SC modulated data associated with the device, the Rx signal including the OFDM modulated data and SC modulated data; and
determine the user data from the Rx signal based on the information.
